(19) United States
(12) Patent Application Publication
(10) Pub. No.: US 2024/0056185 A1
(43) Pub. Date: Feb. 15, 2024

(54) TRANSMISSION DEVICE, COMMUNICATION DEVICE, AND COMMUNICATION SYSTEM

(71) Applicant: NEC Corporation, Tokyo (JP)

(72) Inventors: Koya Takata, Tokyo (JP); Hisashi Mizumoto, Tokyo (JP); Fujio Okumura, Kanagawa (JP)

(73) Assignee: NEC Corporation, Tokyo (JP)

(21) Appl. No.: 18/223,808

(22) Filed: Jul. 19, 2023

(30) Foreign Application Priority Data
Aug. 9, 2022 (JP) 2022-127021

(51) Int. Cl. H04B 10/116; H04B 10/50

(52) U.S. Cl. CPC H04B 10/116; H04B 10/503

(57) ABSTRACT

Provided is a transmission device that includes a light source that includes emitters, a spatial light modulator that includes a modulation part in which modulation regions are set, a concentrator that converts modulated light modulated in the modulation regions into parallel light, a projector that is disposed at a subsequent stage of the concentrator and includes at least one reflector including a curved mirror having a reflection surface of a curved shape having a curvature according to a projection angle of projection light transmitted as a spatial light signal and a rotator rotatably supporting the curved mirror, and a controller that controls the rotator to adjust a reflection direction of the curved mirror for each of the reflectors, sets a phase image used for spatial light communication in the modulation regions, and controls the plurality of emitters such that each of the modulation regions is irradiated with light.

This application is based upon and claims the benefit of priority from Japanese Patent Application No. 2022-127021, filed on Aug. 9, 2022, the disclosure of which is incorporated herein in its entirety by reference.

### TECHNICAL FIELD

The present disclosure relates to a transmission device or the like that transmits an optical signal propagating in a space.

### BACKGROUND ART

In optical space communication, optical signals (hereinafter, also referred to as a spatial light signal) propagating in space are transmitted and received without using a medium such as an optical fiber. In order to transmit the spatial light signal in a wide range, the projection angle of the projection light may be as large as possible. For example, by using a light transmission device including a phase modulation-type spatial light modulator is used, the projection angle can be widened by controlling the pattern set in the modulation part of the spatial light modulator. If the spatial light signal can be transmitted in multiple directions around the light transmission device, a communication network using the spatial light signal can be constructed.

PTL 1 (JP 2019-113752 A) discloses an optical switch device. The device of PTL 1 includes a first light deflecting element and a second light deflecting element. A plurality of optical fibers on the input side are connected to the first light deflecting element. A plurality of optical fibers on the output side are connected to the second light deflecting element. The device of PTL 1 controls the deflection angle of the first light deflecting element and the deflection angle of the second light deflecting element to switch the connection between the optical fibers on the input side and the output side.

PTL 2 (JP 2008-536168 W) discloses an optical device for switching an optical signal. The device of PTL 2 includes an array of rectangular micromirrors having two rotation axes. The device of PTL 2 performs rotation control around the first switching axis to switch the spectral channel to the selected output port. The device of PTL 2 controls the rotation of the micromirror about the second attenuation axis to change the coupling of the spectral channel to the selected output port, thereby controlling the output level of the spectral channel.

The device of PTL 1 controls the deflection angles of the first light deflecting element and the second light deflecting element disposed between the input port and the output port to switch the connection between the plurality of optical fibers. The method of PTL 1 can be applied to the direction control of the laser light inside the device. However, it has been difficult to apply the method of PTL 1 to applications for transmitting various spatial light signals.

The device of PTL 2 switches an output port as an output destination of an optical signal input from an input port by controlling rotation of a micromirror about two axes. In the method of PTL 2, the traveling direction of the optical signal is controlled by continuously driving the micromirror. The method of PTL 2 can be applied to switching of an optical signal inside a module. However, it has been difficult to apply the method of PTL 2 to applications for transmitting spatial light signals in various directions.

An object of the present disclosure is to provide a transmission device and the like capable of transmitting a spatial light signal in an arbitrary direction.

### SUMMARY

A transmission device according to one aspect of the present disclosure includes a light source that includes a plurality of emitters, a spatial light modulator that includes a modulation part in which a plurality of modulation regions are set, a concentrator that converts modulated light modulated in the plurality of modulation regions into parallel light, a projector that is disposed at a subsequent stage of the concentrator and includes at least one reflector including a curved mirror having a reflection surface of a curved shape having a curvature according to a projection angle of projection light transmitted as a spatial light signal and a rotator rotatably supporting the curved mirror, and a controller that controls the rotator to adjust a reflection direction of the curved mirror for each of the reflectors, sets a phase image used for spatial light communication in the plurality of modulation regions, and controls the plurality of emitters such that each of the plurality of modulation regions is irradiated with light.

### BRIEF DESCRIPTION OF THE DRAWINGS

Exemplary features and advantages of the present invention will become apparent from the following detailed description when taken with the accompanying drawings in which:

FIG. 1 is a conceptual diagram illustrating an example of a configuration of a transmission device according to a first example embodiment;

FIG. 2 is a conceptual diagram illustrating an example of a configuration of a light source included in the transmission device according to the first example embodiment;

FIG. 3 is a conceptual diagram illustrating an example of a modulation region set to a modulation part of a spatial light modulator included in the transmission device according to the first example embodiment;

FIG. 4 is a conceptual diagram illustrating an example of a configuration of a reflector included in the transmission device according to the first example embodiment;

FIG. 5 is a conceptual diagram for explaining unnecessary light included in modulated light modulated by the modulation part of the spatial light modulator included in the transmission device according to the first example embodiment;

FIG. 6 is a conceptual diagram for explaining an arrangement example of curved mirrors included in the reflector included in the transmission device according to the first example embodiment;

FIG. 7 is a conceptual diagram for explaining an example of a projection range of projection light reflected by the curved mirror included in the reflector included in the transmission device according to the first example embodiment;

FIG. 8 is a conceptual diagram for explaining an example of projection of projection light reflected by the curved mirror included in the reflector included in the transmission device according to the first example embodiment;

FIG. 9 is a conceptual diagram for explaining an example of irradiation of a reflection surface of the curved mirror included in the reflector included in the transmission device according to the first example embodiment with modulated light;

FIG. 10 is a conceptual diagram for explaining an example of irradiation of the reflection surface of the curved mirror included in the reflector included in the transmission device according to the first example embodiment with modulated light;

FIG. 11 is a conceptual diagram illustrating an example of a configuration of a light source included in a transmission device according to Modification 1 of the first example embodiment;

FIG. 12 is a conceptual diagram illustrating an example of a modulation region set to a modulation part of a spatial light modulator included in the transmission device according to Modification 1 of the first example embodiment;

FIG. 13 is a conceptual diagram for explaining an arrangement example of curved mirrors included in a reflector included in the transmission device according to Modification 1 of the first example embodiment;

FIG. 14 is a conceptual diagram for explaining an example of wavelength multiplexing in a transmission device according to Modification 2 of the first example embodiment;

FIG. 15 is a block diagram illustrating an example of a configuration of a communication device according to a second example embodiment;

FIG. 16 is a conceptual diagram illustrating an example of a configuration of a reception device included in a communication device according to the second example embodiment;

FIG. 17 is a conceptual diagram illustrating an example of a configuration of the reception device included in the communication device according to the second example embodiment;

FIG. 18 is a block diagram illustrating an example of a configuration of a communication device according to Application Example 1 of the second example embodiment;

FIG. 19 is a conceptual diagram illustrating an arrangement example of the communication device according to Application Example 1 of the second example embodiment;

FIG. 20 is a block diagram illustrating an example of a configuration of a communication device according to Application Example 2 of the second example embodiment;

FIG. 21 is a conceptual diagram illustrating an arrangement example of the communication device according to Application Example 2 of the second example embodiment;

FIG. 22 is a conceptual diagram illustrating an example of a configuration of a transmission device according to a third example embodiment; and

FIG. 23 is a block diagram illustrating an example of a hardware configuration that executes processing and control according to each example embodiment.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

In all the drawings used for description of the following example embodiments, the directions of the arrows in the drawings are merely examples, and do not limit the directions of light and signals. A line indicating a trajectory of light in the drawings is conceptual, and does not accurately indicate an actual traveling direction or state of light. For example, in the drawings, a change in a traveling direction or a state of light due to refraction, reflection, diffusion, or the like at an interface between air and a substance may be omitted, or a light flux may be expressed by one line. There is a case where hatching is not applied to the cross section for reasons such as an example of a light path is illustrated or the configuration is complicated.

### First Example Embodiment

First, a transmission device according to a first example embodiment will be described with reference to the drawings. The transmission device of the present example embodiment is used for optical space communication in which optical signals (hereinafter, also referred to as a spatial light signal) propagating in a space are transmitted and received without using a medium such as an optical fiber. The transmission device of the present example embodiment may be used for applications other than optical space communication as long as the transmission device transmits light propagating in a space. The drawings used in the description of the present example embodiment are conceptual and do not accurately depict an actual structure.

(Configuration)

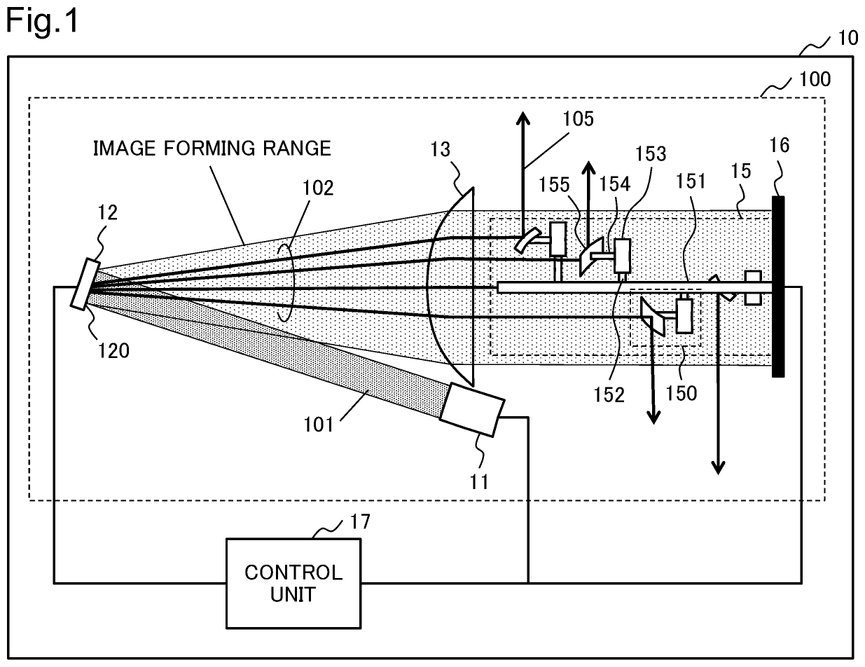

FIG. 1 is a conceptual diagram illustrating an example of a configuration of a transmission device 10 according to the present example embodiment. The transmission device 10 includes a light source 11, a spatial light modulator 12, a plano-convex lens 13, a projection mechanism 15, a light absorber 16, and a control unit 17. The light source 11, the spatial light modulator 12, the plano-convex lens 13, the projection mechanism 15, and the light absorber 16 constitute a transmitter 100. The projection mechanism 15 includes a plurality of reflection units 150. The plurality of reflection units 150 are fixed to a column 151. The reflection unit 150 includes a support rod 152, a rotation mechanism 153, a rotation shaft 154, and a curved mirror 155. FIG. 1 is a side view of an internal configuration of the transmission device 10 as viewed from a lateral direction. FIG. 1 is conceptual, and does not accurately represent a shape of each component, a positional relationship between components, traveling of light, and the like.

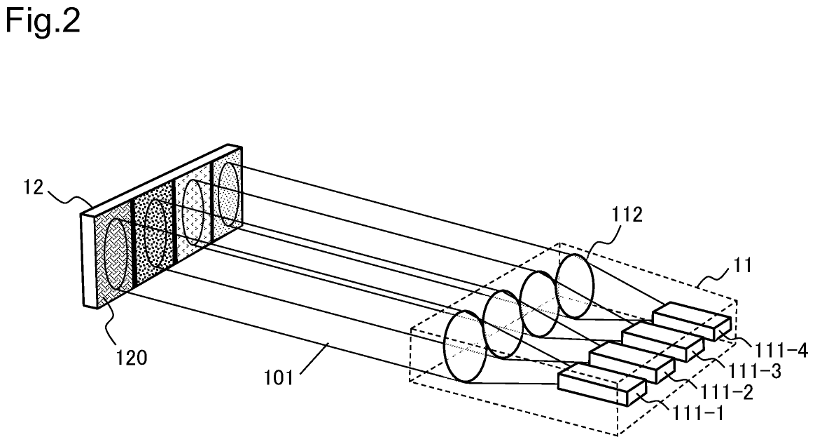

FIG. 2 is a conceptual diagram illustrating an example of a configuration of the light source 11. FIG. 2 is a perspective view of the inside of the light source 11. The light source 11 includes a plurality of emitters 111 (emitters 111-1 to 111-4) and a plurality of collimators 112. Each of the plurality of emitters 111 is associated with one of the plurality of collimators 112. The emitter 111 emits parallel light 101 under the control of the control unit 17. Each of the plurality of emitters 111 is associated with each of the plurality of modulation regions set in a modulation part 120 of the spatial light modulator 12. The emission surfaces of the plurality of emitters 111 are directed to the associated modulation region. In the present example embodiment, the emission surfaces of the plurality of emitters 111 and the modulation part 120 of the spatial light modulator 12 are disposed to face each other. Each of the plurality of emitters 111 emits the parallel light 101 toward the associated modulation region. The number of the emitters 111 included in the light source 11 is not limited to 4. The number of the emitters 111 may be less than 4 or may be 5 or more.

The emitter 111 included in the light source 11 emits laser light in a predetermined wavelength band under the control of the control unit 17. The wavelength of the laser light emitted from the emitter 111 is not particularly limited, and may be selected according to the application. For example, the emitter 111 emits laser light in visible or infrared wavelength bands. For example, in the case of near-infrared rays of 800 to 1000 nanometers (nm), as compared with the visible light, the laser class can be given, and thus the sensitivity can be improved more than the visible light. For example, a higher-power laser light source than the near-infrared rays of 800 to 1000 nm can be used if the infrared rays have a wavelength band of 1.55 micrometers (μm). As a laser light source that emits infrared rays in a wavelength band of 1.55 μm, an aluminum gallium arsenide phosphorus (AlGaAsP)-based laser light source, an indium gallium arsenide (InGaAs)-based laser light source, or the like can be used. The longer the wavelength of the laser light is, the larger the diffraction angle can be made and the higher the energy can be set.

The collimator 112 is disposed in each of the plurality of emitters 111. The collimator 112 converts the laser light emitted from the emitter 111 into the parallel light 101. The converted parallel light 101 is emitted from the light source 11. The parallel light 101 emitted from the light source 11 travels toward the modulation part 120 of the spatial light modulator 12. The collimator may be omitted according to the distance between the light source 11 and the spatial light modulator 12 or the like.

The spatial light modulator 12 is a phase modulation-type spatial light modulator. The spatial light modulator 12 includes the modulation part 120. A plurality of modulation regions are set in the modulation part 120. The number of modulation regions set in the modulation part 120 is set in accordance with the number of emitters 111 included in the light source 11.

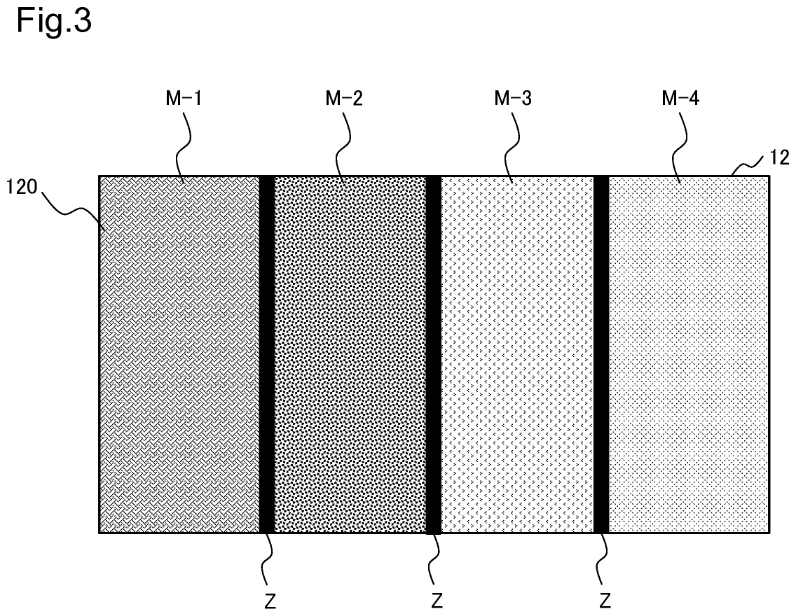

FIG. 3 is a conceptual diagram illustrating an example of a plurality of modulation regions M set in the modulation part 120. In the example of FIG. 3, four modulation regions M-1 to M-4 are set. A dead zone Z is set between the adjacent modulation regions M. A black stripe-shaped phase image is set in the dead zone Z. Each of the plurality of modulation regions M-1 to M-4 is associated with each of the plurality of emitters 111-1 to 111-4 included in the light source 11. The plurality of emitters 111-1 to 111-4 and the plurality of modulation regions M-1 to M-4 are associated with each other in a front positional relationship. Each of the plurality of modulation regions M-1 to M-4 is irradiated with the parallel light 101 derived from the laser light emitted from each of the associated emitters 111-1 to 111-4.

The modulation region M-1 is irradiated with the parallel light 101 derived from the laser light emitted from the emitter 111-1. The modulation region M-2 is irradiated with the parallel light 101 derived from the laser light emitted from the emitter 111-2. The modulation region M-3 is irradiated with the parallel light 101 derived from the laser light emitted from the emitter 111-3. The modulation region M-4 is irradiated with the parallel light 101 derived from the laser light emitted from the emitter 111-4. When the parallel light 101 derived from the laser light emitted from the emitter 111 is incident on the modulation surface of the modulation region M, the correspondence relationship between the modulation region M and the emitter 111 is not limited to the above correspondence relationship.

A pattern (also referred to as a phase image) corresponding to the image displayed by projection light 105 is set in each of the plurality of modulation regions M-1 to M-4 under the control of the control unit 17. The parallel light 101 incident on each of the plurality of modulation regions M-1 to M-4 set in the modulation part 120 is modulated according to the pattern (phase image) set in each of the plurality of modulation regions M-1 to M-4. Modulated light 102 modulated in each of the plurality of modulation regions M-1 to M-4 travels toward the reflection surface of the curved mirror 155 included in the reflection unit 150 associated with each of the modulation regions M-1 to M-4 via the plano-convex lens 13.

The plurality of modulation regions M are divided into a plurality of regions (also referred to as tiling). For example, the modulation region M is divided into regions (also referred to as tiles) having a desired aspect ratio. A phase image is allocated to each of the plurality of tiles set in the modulation region M. Each of the plurality of tiles includes a plurality of pixels. A phase image relevant to a projected image is set to each of the plurality of tiles. A phase image is tiled to each of the plurality of tiles allocated to the modulation region M. For example, a phase image generated in advance is set in each of the plurality of tiles. When the modulation region M is irradiated with the parallel light 101 in a state where the phase image is set in the plurality of tiles, the modulated light 102 that forms an image relevant to the phase image of each tile is emitted. As the number of tiles set in the modulation region M increases, a clear image can be displayed. However, when the number of pixels of each tile decreases, the resolution decreases. Therefore, the size and number of tiles set in the modulation region M are set according to the application.

For example, the spatial light modulator 12 is achieved by a spatial light modulator using ferroelectric liquid crystal, homogeneous liquid crystal, vertical alignment liquid crystal, or the like. For example, the spatial light modulator 12 can be achieved by liquid crystal on silicon (LCOS). The spatial light modulator 12 may be achieved by a micro electro mechanical system (MEMS). In the phase modulation-type spatial light modulator 12, the energy can be concentrated on the portion of the image by operating to sequentially switch the portion on which the projection light 105 is projected. Therefore, in the case of using the phase modulation-type spatial light modulator 12, if the output of the light source 11 is the same, the image can be displayed brighter than other methods.

The plano-convex lens 13 (also referred to as a concentrator) is disposed between the spatial light modulator 12 and the projection mechanism 15. The plano-convex lens 13 has a curved incident surface and a planar emission surface. An incident surface (curved surface) of the plano-convex lens 13 is directed to the spatial light modulator 12. An emission surface (plane) of the plano-convex lens 13 is directed to the projection mechanism 15. The modulated light 102 modulated by the modulation part 120 of the spatial light modulator 12 is incident on the plano-convex lens 13. The plano-convex lens 13 converts the incident modulated light 102 into parallel light. The modulated light 102 converted into the parallel light is emitted toward the projection mechanism 15. In the present example embodiment, the modulated light 102 modulated in each of the plurality of modulation regions M-1 to M-4 is emitted toward a reflection surface 1550 of the curved mirror 155 of the reflection unit 150 associated with each of the modulation regions M-1 to M-4.

For example, the plano-convex lens 13 can be made of a material such as glass, crystal, or resin. In the case of receiving a spatial light signal in the visible region, the plano-convex lens 13 can be achieved by a material such as glass, crystal, or resin that transmits/refracts light in the visible region. For example, optical glass such as crown glass or flint glass can be applied to the plano-convex lens 13. For example, crown glass such as BK (Boron Kron) can be applied to the plano-convex lens 13. For example, the plano-convex lens 13 can be achieved by flint glass such as Lanthanum Schwerflint (LaSF). For example, quartz glass can be applied to the plano-convex lens 13. For example, a crystal such as sapphire can be applied to the plano-convex lens 13. For example, a transparent resin such as acrylic can be applied to the plano-convex lens 13.

In a case where the spatial light signal is light in a near-infrared region (hereinafter, also referred to as near-infrared rays), a material that transmits near-infrared rays is used for the plano-convex lens 13. For example, in a case of receiving a spatial light signal in a near-infrared region of about 1.5 micrometers (μm), a material such as silicon can be applied to the plano-convex lens 13 in addition to glass, crystal, resin, and the like. In a case where the spatial light signal is light in an infrared region (hereinafter, also referred to as infrared rays), a material that transmits infrared rays is used for the plano-convex lens 13. For example, in a case where the spatial light signal is an infrared ray, silicon, germanium, or a chalcogenide material can be applied to the plano-convex lens 13. The material of the plano-convex lens 13 is not limited as long as light in the wavelength region of the spatial light signal can be transmitted/refracted. The material of the plano-convex lens 13 may be appropriately selected according to the required refractive index and use.

The projection mechanism 15 (projector) includes a plurality of reflection units 150. The reflection unit 150 (reflector) includes a support rod 152, a rotation mechanism 153, a rotation shaft 154, and a curved mirror 155. The plurality of reflection units 150 are fixed to a column 151. The column 151 is a column to which the plurality of reflection units 150 are fixed. The column 151 is fixed to the housing of the transmission device 10. The column 151 is a rod-shaped member extending in a direction perpendicular to the emission surface (plane) of the plano-convex lens 13. That is, the column 151 extends in a direction perpendicular to the optical axis of the plano-convex lens 13.

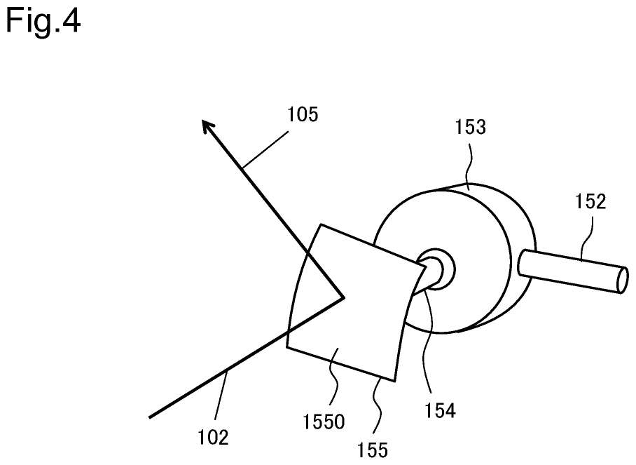

FIG. 4 is a conceptual diagram illustrating an example of a configuration of the reflection unit 150 included in the projection mechanism 15. The reflection unit 150 is irradiated with the modulated light 102 modulated by any of the plurality of modulation regions M set in the modulation part 120 of the spatial light modulator 12. In the present example embodiment, one of the four reflection units 150 is irradiated with the modulated light 102 modulated in one of the four modulation regions M. The reflection unit 150 irradiated with the modulated light 102 modulated in each of the plurality of modulation regions M can be arbitrarily exchanged according to the projection direction of the projection light 105 or the like. The reflection unit 150 includes a curved mirror 155, a rotation mechanism 153, a rotation shaft 154, and a support rod 152. The reflection unit 150 is fixed to the column 151 by the support rod 152.

The support rod 152 is a member that fixes the rotation mechanism 153 to the column 151. In the present example embodiment, the axial direction of the support rod 152 is perpendicular to the extending direction of the column 151. The axial direction of the support rod 152 may be non-perpendicular to the extending direction of the column 151.

The rotation mechanism 153 (rotator) is an electric motor supported by the support rod 152 on the column 151. The rotation mechanism 153 rotatably supports the curved mirror 155. In the present example embodiment, the rotation surface of the rotation mechanism 153 is perpendicular to the extending direction of the column 151. The rotation surface of the rotation mechanism 153 may be non-perpendicular to the extending direction of the column 151. The rotation shaft 154 is installed in the rotation mechanism 153. The rotation mechanism 153 rotates the rotation shaft 154 under the control of the control unit 17. For example, the rotation mechanism 153 is achieved by a motor such as a stepping motor capable of controlling the rotation angle. In the case of the stepping motor, the rotation angle can be controlled according to the number of pulses of the pulse signal input to the drive unit (not illustrated).

The rotation shaft 154 is rotatably supported by the rotation mechanism 153. The rotation shaft 154 rotatably supports the curved mirror 155 on the rotation mechanism 153. In the present example embodiment, the axial direction of the rotation shaft 154 is perpendicular to the extending direction of the column 151. That is, the optical axis of the plano-convex lens 13 coincides with the axial direction of the rotation shaft 154. When the optical axis of the modulated light 102 converted into the parallel light coincides with the axial direction of the rotation shaft 154, the spatial light signal can be transmitted in the direction of 360 degrees by rotating the reflection surface 1550 of the curved mirror 155. When the transmission direction of the spatial light signal may be limited, the axial direction of the rotation shaft 154 may be non-perpendicular to the extending direction of the column 151. The rotation shaft 154 rotates in accordance with driving of the rotation mechanism 153. The direction of the reflection surface 1550 of the curved mirror 155 changes according to the rotation of the rotation shaft 154.

The curved mirror 155 is rotatably supported by the rotation mechanism 153 by the rotation shaft 154. The curved mirror 155 is a reflecting mirror having the curved reflection surface 1550. The reflection surface 1550 of the curved mirror 155 is adjusted to an angle according to a projection direction of the projection light 105. The reflection surface 1550 of the curved mirror 155 has a curvature corresponding to the projection angle of the projection light 105. For example, the curvature of the reflection surface 1550 of the curved mirror 155 is adjusted such that the projection angle of the projection light 105 becomes about 6 degrees. The shape of the reflection surface 1550 of the curved mirror 155 is not limited as long as it includes a curved portion. For example, the reflection surface 1550 of the curved mirror 155 has a shape of a side surface of a cylinder. For example, the reflection surface 1550 of the curved mirror 155 may be a free-form surface or a spherical surface. For example, the reflection surface 1550 of the curved mirror 155 may have a shape in which a plurality of curved surfaces are combined instead of a single curved surface. For example, the reflection surface 1550 of the curved mirror 155 may have a shape in which a curved surface and a flat surface are combined.

The curved mirror 155 is disposed with the reflection surface 1550 facing the modulation part 120 of the spatial light modulator 12. The curved mirror 155 is disposed on an optical path of the modulated light 102 modulated in the associated modulation region M. The curved mirror 155 is disposed at a position where an unnecessary light component (also referred to as unnecessary light) is not irradiated in the modulated light 102 modulated in the associated modulation region M. The reflection surface 1550 is irradiated with a light component of a projection target (also referred to as desired light) out of the modulated light 102 modulated by the modulation part 120. The modulated light 102 irradiated to the reflection surface 1550 is reflected by the reflection surface 1550. The light (projection light 105) reflected by the reflection surface 1550 is enlarged at an enlargement ratio corresponding to the curvature of the reflection surface 1550 and projected. Since the reflection surface 1550 has the curvature, an adjustment range of the projection angle of the projection light 105 according to the modulated light 102 emitted to the range where the curved mirror 155 is disposed is widened. Instead of the curved mirror 155, a flat mirror can also be applied. However, compared with the curved mirror 155, the adjustment range of the projection angle of the projection light 105 is narrow in the flat mirror. A lens (not illustrated) may be disposed at a subsequent stage of the curved mirror 155 in order to limit the spread of the projection light 105.

The reflection surface 1550 of the curved mirror 155 included in each of the plurality of reflection units 150 is directed to the modulation part 120 of the spatial light modulator 12. The light (projection light 105) reflected by the reflection surface 1550 of the curved mirror 155 is enlarged according to the curvature of the irradiation range of the modulated light 102 on the reflection surface 1550. The projection light 105 spreads as it goes away from the transmission device 10.

The curved mirror 155 included in each of the plurality of reflection units 150 is disposed with the reflection surface 1550 facing different directions. The curved mirror 155 included in each of the plurality of reflection units 150 may be adjusted so as to direct the reflection surface 1550 in the same direction. In FIG. 1, the projection light 105 is projected in a direction perpendicular to the extending direction of the column 151. The projection light 105 is transmitted as a spatial light signal through a slit (not illustrated) opened in a housing of the transmission device 10.

The light absorber 16 is a member that absorbs light. The light absorber 16 is disposed on an optical path of a light component that is not projected as the projection light 105 among the modulated light 102 condensed by the plano-convex lens 13. For example, the light absorber 16 is disposed inside the housing. For example, the light absorber 16 is a black body such as carbon. The material of the light absorber 16 is not limited as long as the material has a high light absorption rate. Similarly to the light absorber 16, a member that absorbs light may be provided on the surfaces of the column 151, the support rod 152, the rotation mechanism 153, and the rotation shaft 154.

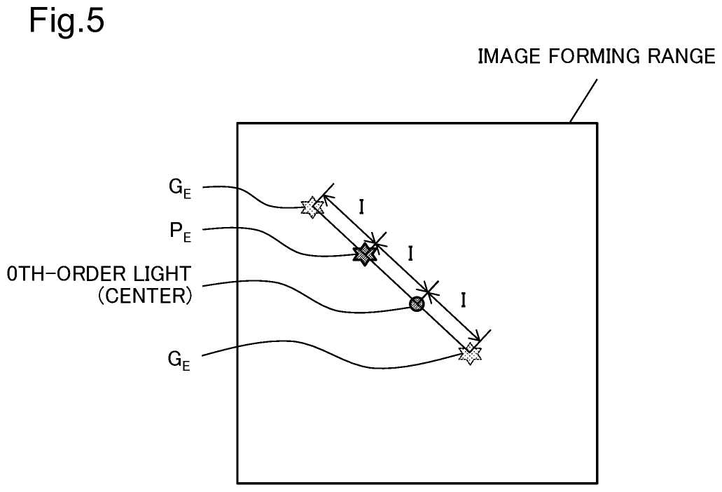

FIG. 5 is a conceptual diagram for explaining an image formed by the modulated light 102 modulated by the modulation part 120 of the spatial light modulator 12. FIG. 5 illustrates an image forming range in the projection mechanism 15 at the subsequent stage of the plano-convex lens 13. In the case of using the phase modulation-type spatial light modulator 12, an image is formed using a diffraction phenomenon, so that a higher-order image is generated similarly to the diffraction grating. In the example of FIG. 5, a 0th-order image (desired image PE) to be projected is displayed in the image forming range. The 0th-order light is displayed in the image forming range. In the image forming range, a higher-order image (ghost image GE) is displayed at a point symmetric position of the desired image PE with the 0th-order light as the center or at a position separated from the 0th-order light by an equal interval I. An image of a 1st-order or higher-order is a higher-order image. Since the power of a higher-order image decreases as the order increases, it becomes more difficult to visually recognize the higher-order image as the order increases. However, higher-order images are not completely invisible. The 0th-order light and the higher-order images are unnecessary light components (unnecessary light). In the present example embodiment, the curved mirror 155 is disposed avoiding a position where unnecessary light such as the 0th-order light or the higher-order images are projected. Therefore, in the present example embodiment, the projection light 105 on which a desired image not including unnecessary light is formed is projected.

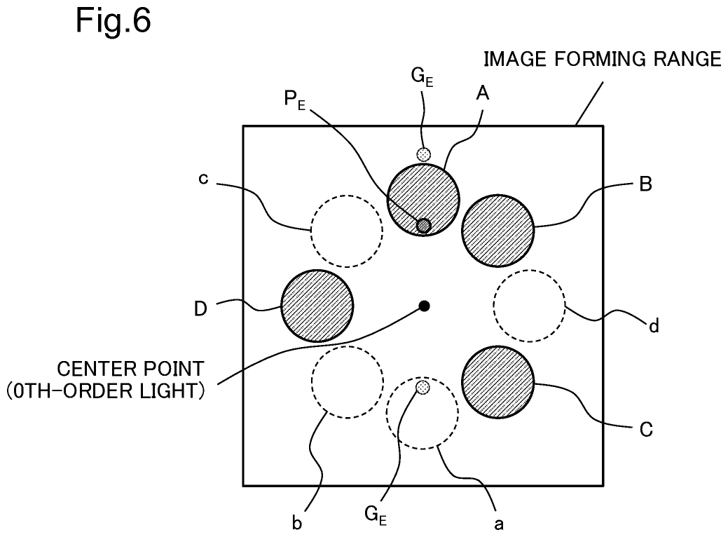

FIG. 6 is a conceptual diagram for explaining a position where the curved mirror 155 is disposed. FIG. 6 illustrates an image forming range in the projection mechanism 15 at the subsequent stage of the plano-convex lens 13. The 0th-order light is displayed at the position of the center point. The plurality of curved mirrors 155 are disposed on an arc centered on the position of the 0th-order light. The curved mirror 155 is disposed in a region (region A, region B, region C, region D) in a circle filled with hatching. In a region (region a, region b, region c, region d) in a circle surrounded by a broken line, the ghost image GE of the desired image PE displayed in the region where the curved mirror 155 is disposed is displayed. The regions a to d are point-symmetric with respect to the regions A to D with the position of the 0th-order light as the center. As illustrated in FIG. 6, the ghost image GE of the desired image PE displayed in region A is displayed in region a. Similarly, ghost images of desired images displayed in the regions B to D are displayed in the regions b to d (not illustrated). The ghost image GE of the desired image PE displayed in region A is displayed in the vicinity of region A. Similarly, the ghost images of the desired images displayed in the regions B to D are displayed in the vicinity of the regions B to D (not illustrated). The curved mirror 155 is set to such a size that the higher-order light (first-order light) in the same direction is not incident on a position of the 0th-order light.

The control unit 17 (controller) controls the light source 11, the spatial light modulator 12, and the rotation mechanism 153. For example, the control unit 17 is achieved by a microcomputer including a processor and a memory. The control unit 17 controls the rotation mechanism 153 such that the reflection surface 1550 of the curved mirror 155 faces the transmission direction set by the administrator or the like of transmission device 10. The timing of controlling the rotation mechanism 153 may be set in advance. The control unit 17 sets a phase image relevant to the projected image in the modulation part 120 in accordance with the aspect ratio of tiling set in the modulation part 120 of the spatial light modulator 12. The control unit 17 sets a phase image relevant to the projected image in each of the plurality of modulation regions M set in the modulation part 120 of the spatial light modulator 12. For example, the control unit 17 sets, in the modulation part 120, a phase image relevant to an image according to a use such as image display, communication, or distance measurement. The phase image of the projected image may be stored in advance in a storage unit (not illustrated). The shape and size of the image to be projected are not particularly limited.

The control unit 17 controls the spatial light modulator 12 such that a parameter that determines a difference between a phase of the parallel light 101 irradiated to the modulation part 120 and a phase of the modulated light 102 reflected by the modulation part 120 changes. For example, the parameter is a value related to optical characteristics such as a refractive index and an optical path length. For example, the control unit 17 adjusts the refractive index of the modulation part 120 by changing the voltage applied to the modulation part 120 of the spatial light modulator 12. The phase distribution of the parallel light 101 with which the modulation part 120 of the phase modulation-type spatial light modulator 12 is irradiated is modulated according to the optical characteristics of the modulation part 120. The method of driving the spatial light modulator 12 by the control unit 17 is determined according to the modulation scheme of the spatial light modulator 12.

The control unit 17 drives the light source 11 in a state where the phase image relevant to the image to be displayed is set in the modulation part 120. As a result, the parallel light 101 emitted from the light source 11 is irradiated to the modulation part 120 of the spatial light modulator 12 in accordance with the timing at which the phase image is set in the modulation part 120 of the spatial light modulator 12. The parallel light 101 emitted to the modulation part 120 of the spatial light modulator 12 is modulated by the modulation part 120 of the spatial light modulator 12. The modulated light 102 modulated by the modulation part 120 of the spatial light modulator 12 is emitted toward the reflection surface 1550 of the curved mirror 155.

The control unit 17 modulates the parallel light 101 emitted from the light source 11 for communication with a communication target (not illustrated). In communication, the control unit 17 modulates the parallel light 101 by controlling a timing at which the parallel light 101 is emitted from the light source 11 in a state in which the phase image for communication is set in the modulation part 120 of the spatial light modulator 12. The modulation pattern of the parallel light 101 in the communication is arbitrarily set. For example, a configuration for communication (communication unit) may be added separately from the control unit 17. In that case, the control unit 17 may be configured to control the light source 11 and the spatial light modulator 12 according to the condition set by the communication unit.

For example, the projection angle of the projection light 105 can be set to an angle by adjusting the curvature of the reflection surface 1550 of the curved mirror 155 included in the transmission device 10 and the distance between the spatial light modulator 12 and the curved mirror 155. If the plane mirror is disposed on the optical path of the modulated light 102 inside the transmission device 10, the projection angle of the projection light 105 can be variously set. For example, a transmission device 10 configured to project projection light in a direction of 360 degrees and a reception device configured to receive a spatial light signal arriving from a direction of 360 degrees are combined. With such a configuration, it is possible to achieve a communication device that transmits a spatial light signal in a direction of 360 degrees and receives a spatial light signal arriving from a direction of 360 degrees.

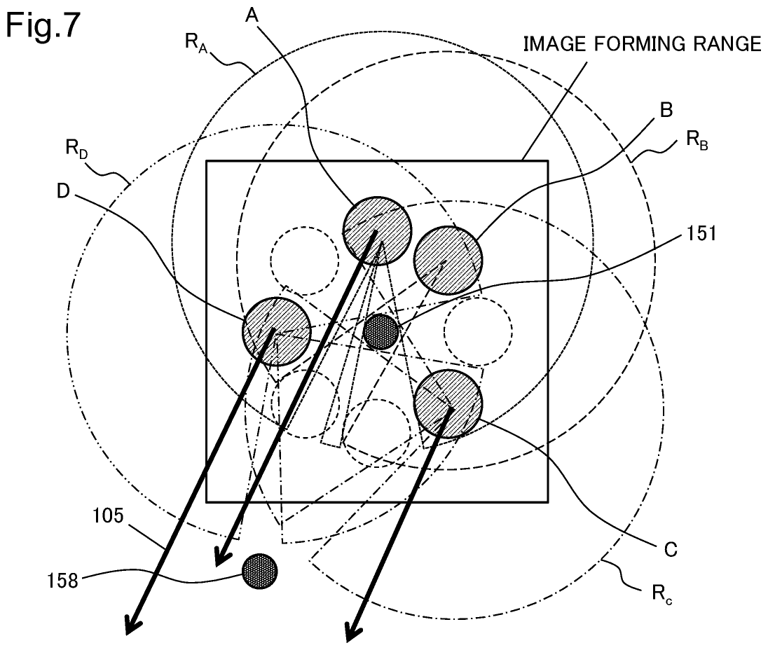

FIG. 7 is a conceptual diagram for explaining a transmission range of projection light 105 (spatial light signal) reflected by the curved mirror 155. FIG. 7 illustrates an image forming range in the projection mechanism 15 at the subsequent stage of the plano-convex lens 13. The column 151 is disposed at a position where the 0th-order light is displayed. FIG. 7 illustrates the position of a column 158 for arranging wiring or the like for connecting the control unit 17 and the substrate (not illustrated). FIG. 7 illustrates a projection range of the projection light 105 reflected by the curved mirror 155 disposed in the regions A to D. A projection range RA of the curved mirror 155 disposed in region A is within a range indicated by a dotted line. A projection range RB of the curved mirror 155 disposed in region B is within a range indicated by a broken line. A projection range RC of curved mirror 155 disposed in region C is within a range indicated by an alternate long and short dash line. A projection range RD of the curved mirror 155 disposed in region D falls within a range indicated by a two-dot chain line. The projection range RA, the projection range RB, the projection range RC, and the projection range RD are set to ranges avoiding the column 151 and the column 158.

In FIG. 7, an example of the projection direction of the projection light 105 projected in the directions of the column 151 and the column 158 is indicated by an arrow. In the example of FIG. 7, the projection light 105 reflected by the curved mirror 155 disposed in region B is hindered by the column 151 and the column 158 in the direction of the arrow. However, the three curved mirrors 155 arranged in region A, region C, and region D can project the projection light 105 (spatial light signal) in the directions of the column 151 and the column 158. That is, in the example of FIG. 7, the projection range that cannot be covered by the curved mirror 155 disposed in region B can be covered by three curved mirrors 155 disposed in region A, region C, and region D. Therefore, according to the method of the present example embodiment, the spatial light signal can be transmitted in the direction of 360 degrees.

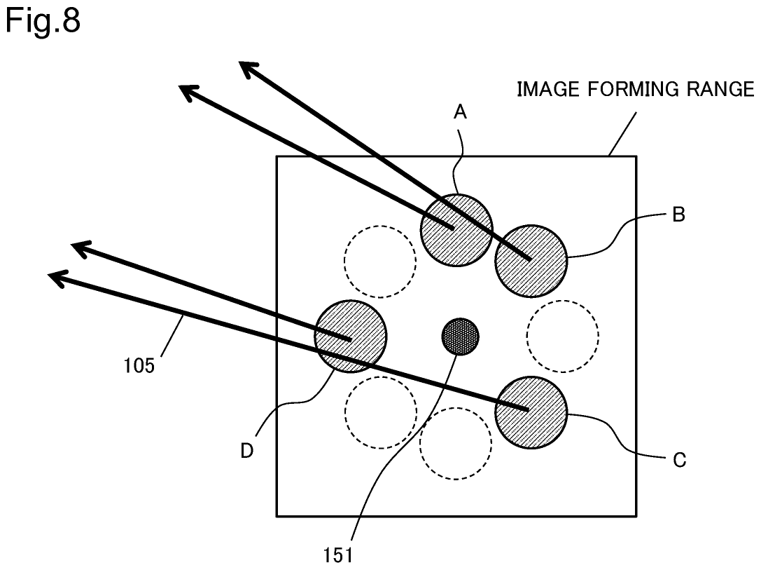

FIG. 8 is a conceptual diagram for explaining an example of a transmission direction of a spatial light signal by the transmission device 10. FIG. 8 illustrates an image forming range in the projection mechanism 15 at the subsequent stage of the plano-convex lens 13. In the example of FIG. 8, the spatial light signal (projection light 105) is transmitted by four curved mirrors 155 in a narrow transmission direction of about 30 degrees. For example, when a plurality of communication targets are within a narrow projection range, it is necessary to transmit different spatial light signals to the communication targets. In such a case, when a plurality of spatial light signals are transmitted to a narrow range as illustrated in FIG. 8 using the plurality of curved mirrors 155, communication with each communication target can be individually performed.

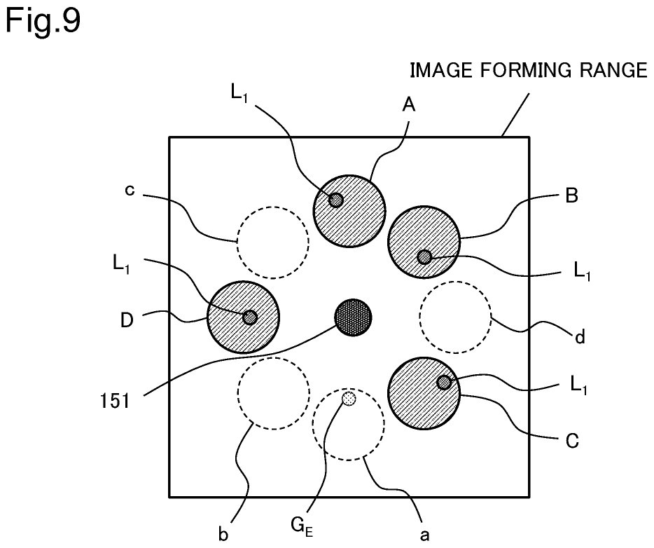

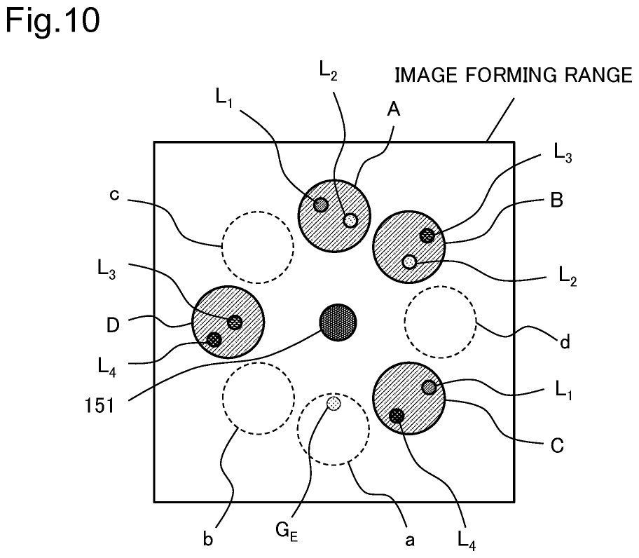

FIGS. 9 and 10 are conceptual diagrams for explaining the degree of freedom of the irradiation pattern of the modulated light 102 derived from the laser light emitted from the plurality of emitters 111-1 to 111-4 included in the light source 11. FIGS. 9 and 10 illustrate an image forming range in the projection mechanism 15 at the subsequent stage of the plano-convex lens 13. In FIGS. 9 and 10, hatching indicates an indication of positions of beams (beam L1, beam L2, beam L3, and beam L4) with which a plurality of regions are irradiated.

FIG. 9 illustrates an example in which a plurality of regions are irradiated with beam L1 derived from the laser light emitted from a single emitter 111-1. In the example of FIG. 9, a plurality of regions (A, B, C, D) are irradiated with the beam L1 from the emitter 111-1. When the modulated light 102 derived from the laser light emitted from the single emitter 111 is reflected by the plurality of curved mirrors 155, the same spatial light signal can be simultaneously transmitted to the plurality of communication targets.

FIG. 10 illustrates an example in which the same region is irradiated with the modulated light 102 derived from the laser light emitted from the plurality of emitters 111-1. Region A and region C are irradiated with beam L1 from the emitter 111-1. Region A and region B are irradiated with beam L2 from the emitter 111-2. Region B and region D are irradiated with beam L3 from the emitter 111-3. Region C and region D are irradiated with beam L4 from the emitter 111-4. The spatial light signal can be spatially multiplexed by reflecting the modulated light 102 derived from the laser light from the plurality of emitters 111 by the plurality of curved mirrors 155. By using the spatially multiplexed spatial light signal, it is possible to transmit spatial light signals received through different channels to the same communication target. In a case where a plurality of communication targets are close to each other, spatial light signals for the communication targets can be individually transmitted by using the spatially multiplexed spatial light signals.

(Modifications)

Next, modifications of the present example embodiment will be described. Hereinafter, a modification (Modification 1) in which the number of light sources 11 is increased and a modification (Modification 2) in which the wavelengths of the spatial light signals are multiplexed will be described. The following modifications are merely examples and do not limit the modifications of the present example embodiment.

### [Modification 1]

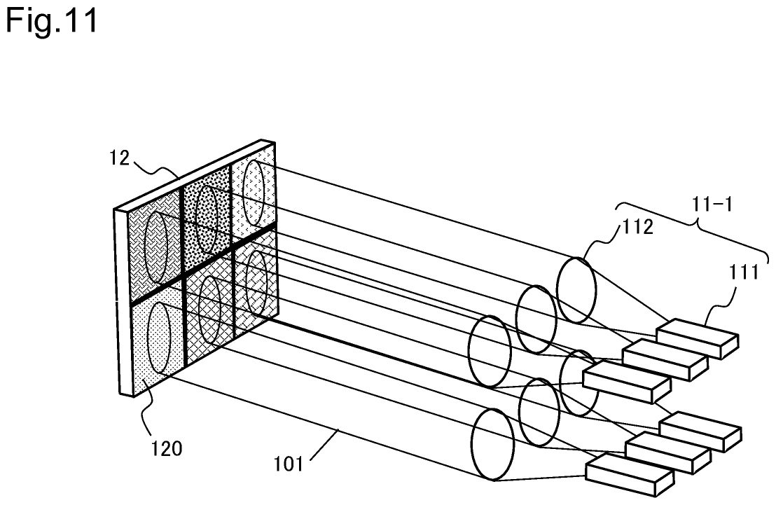

FIG. 11 is a conceptual diagram for explaining Modification 1. FIG. 11 is a diagram of the inside of the transmission device in which as light source 11-1 of the present modification is disposed as viewed obliquely from the rear. The light source 11-1 includes six emitters 111 and six collimators 112. Each of the plurality of emitters 111 is associated with one of the collimators 112. The six emitters 111 and the six collimators 112 are arranged in a lattice of 2 rows×3 columns. The parallel light 101 derived from the laser light emitted from the plurality of light emitters 111 arranged in a lattice is applied to one of the plurality of modulation regions M set in the modulation part 120 of the spatial light modulator 12.

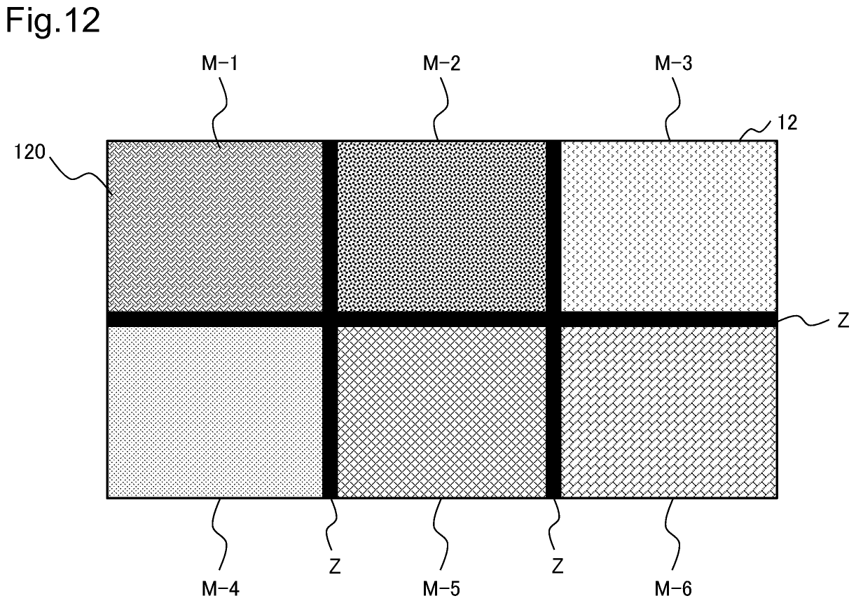

FIG. 12 is a conceptual diagram illustrating an example of a plurality of modulation regions M set in the modulation part 120. In the example of FIG. 12, six modulation regions M-1 to M-6 arranged in a lattice of 2 rows×3 columns are set. A dead zone Z is set between the adjacent modulation regions M. A black stripe-shaped phase image is set in the dead zone Z. Each of the plurality of modulation regions M-1 to M-6 is associated with each of the plurality of emitters 111 included in the light source 11. The plurality of emitters 111 and the plurality of modulation regions M-1 to M-6 are associated with each other in a front positional relationship. Each of the plurality of modulation regions M-1 to M-6 is irradiated with the parallel light 101 derived from the laser light emitted from the associated emitter 111. As long as the parallel light 101 derived from the laser light emitted from the emitter 111 is incident on the modulation surface of the modulation region M, the correspondence relationship between the modulation region M and the emitter 111 is not limited.

A pattern (phase image) corresponding to the image displayed by the projection light 105 is set in each of the plurality of modulation regions M-1 to M-6 under the control of the control unit 17. The parallel light 101 incident in each of the plurality of modulation regions M-1 to M-6 set in the modulation part 120 is modulated according to the pattern (phase image) set in each of the plurality of modulation regions M-1 to M-6. The modulated light 102 modulated in each of the plurality of modulation regions M-1 to M-6 travels toward the reflection surface of the curved mirror 155 included in the reflection unit 150 associated with each of the modulation regions M-1 to M-6 via the plano-convex lens 13.

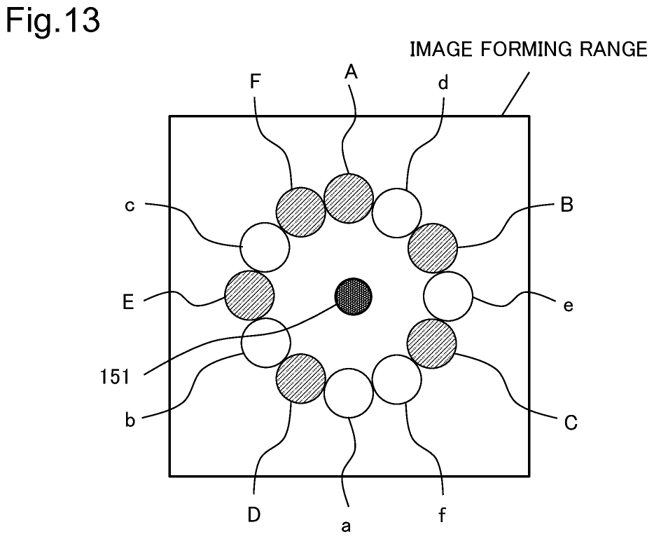

FIG. 13 is a conceptual diagram for explaining a position where the curved mirror 155 is disposed. FIG. 13 illustrates an image forming range in the projection mechanism 15 at the subsequent stage of the plano-convex lens 13. The 0th-order light is displayed at the position of the column 151 disposed at the center point. The plurality of curved mirrors 155 are disposed on an arc centered on the column 151. The curved mirror 155 is disposed in a region (region A, region B, region C, region D, region E, region F) in a circle filled with hatching. In a region (region a, region b, region c, region d, region e, region f) in a circle surrounded by a broken line, a ghost image of a desired image displayed in a region where the curved mirror 155 is disposed is displayed. The regions a to f are point-symmetric with respect to the regions A to F with the position of the 0th-order light as the center. The ghost images of the desired images displayed in the regions A to F are displayed in regions a to f (not illustrated). The ghost images of the desired images displayed in the regions A to F are displayed in the vicinity of the regions A to F (not illustrated). The curved mirror 155 is set to such a size that the higher-order light (first-order light) in the same direction is not incident on a position of the 0th-order light.

In the present modification, an example of the light source 11-1 including the six emitters 111 has been described. The number of the emitters 111 can be set according to the application. For example, the plurality of emitters 111 may be disposed in three or more rows in an overlapping manner. In the modulation part 120 of the spatial light modulator 12, a modulation region M corresponding to the number of emitters is set. In order to correspond to the examples illustrated in FIGS. 9 and 10, the number of the emitters 111 and the number of the modulation regions M may be different. As the number of the emitters 111 increases, the size of the curved mirror 155 decreases and the curvature increases. Therefore, the curved mirror 155 is easily disposed so as to avoid the ghost image. Even when the number of the emitters 111 increases, there is no change in the formed image.

### [Modification 2]

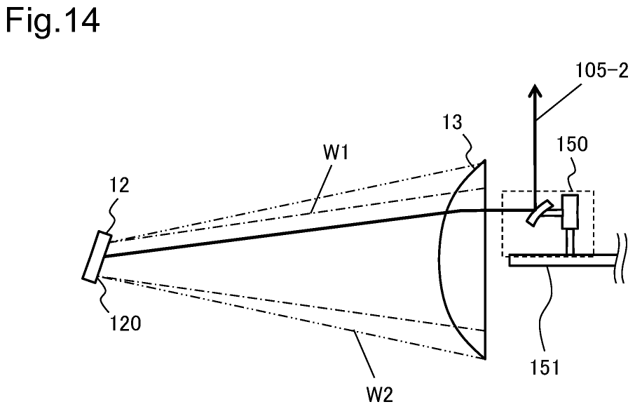

FIG. 14 is a conceptual diagram for explaining Modification 2. FIG. 14 is a view seen from a side viewing seat. In the present modification, spatial light signals having different wavelengths are wavelength-multiplexed using the same reflection unit 150.

In the example of FIG. 14, a spatial light signal having a wavelength W1 and a wavelength W2 is transmitted. The angle of view of the image forming range formed by the modulated light 102 modulated by the modulation part 120 of the spatial light modulator 12 depends on the wavelength of the laser light emitted from the emitter 111. The larger the wavelength of the laser light, the wider the angle of view. In the example of FIG. 14, the wavelength W2 (two-dot chain line) is larger than the wavelength W1 (one-dot chain line). By irradiating different positions of the modulation part 120 with the laser light (parallel light 101) emitted from emitters 111 having different wavelengths according to the wavelengths, the modulated light 102 passing through the same point can be formed. In this way, the spatial light signals (projection light 105-2) including light components having different wavelengths can be multiplexed and transmitted in the same direction. That is, according to the method of the present modification, it is possible to transmit the wavelength-multiplexed spatial light signal to the same communication target. The number of wavelengths to be multiplexed can be set to three or more according to the number of the emitters 111.

In the case of using the method of the present modification, the communication target (not illustrated) may include a light receiving element that receives light of a plurality of wavelength bands. The optical signal reaching the communication target is received by the light receiving element corresponding to the wavelength band.

As described above, the transmission device of the present example embodiment includes the light source, the spatial light modulator, the concentrator, the projector, the light absorber, and the controller. The light source includes a plurality of emitters. For example, the plurality of emitters emit laser light. The spatial light modulator includes a modulation part in which a plurality of modulation regions are set. The concentrator converts the modulated light modulated in the plurality of modulation regions into parallel light. For example, the concentrator is a plano-convex lens disposed with a convex surface facing the modulation part of the spatial light modulator and a flat surface facing the projector. The projector is disposed at a subsequent stage of the concentrator. The projector includes at least one reflector. The at least one reflector is supported on a column extending perpendicular to the optical axis of the concentrator. The reflector includes a rotator and a curved mirror. The curved mirror has a curved reflection surface having a curvature corresponding to the projection angle of the projection light transmitted as the spatial light signal. The curved mirror is disposed at a position avoiding a region where the 0th-order light and the higher-order images included in the modulated light are projected. The rotator rotatably supports the curved mirror. The control unit adjusts the reflection direction of the curved mirror for each reflector by controlling the rotator. The controller sets a phase image used for spatial light communication in a plurality of modulation regions. The controller controls the plurality of emitters so that each of the plurality of modulation regions is irradiated with light. The light absorber absorbs light components that are not reflected by the projector in the light collected by the concentrator.

In the present example embodiment, the plurality of modulation regions set in the modulation part of the spatial light modulator are irradiated with the parallel light derived from the laser light emitted from the plurality of emitters. The light component of the spatial light signal included in the modulated light modulated in the plurality of modulation regions is transmitted as a spatial light signal by one of the curved mirrors associated with each of the plurality of modulation regions. The direction of the reflection surface of the curved mirror is adjusted by the controller for each reflector. Therefore, according to the transmission device of the present example embodiment, the spatial light signal can be transmitted in an arbitrary direction by adjusting the direction of the reflection surface of the curved mirror for each reflector.

In one aspect of the present example embodiment, the controller controls the light source such that modulated light derived from light emitted from at least one of the plurality of emitters is emitted toward the curved mirrors included in the plurality of reflectors. According to the present aspect, the modulated light derived from the light emitted from the single emitter is reflected by the plurality of curved mirrors, whereby the same spatial light signal can be simultaneously transmitted to the plurality of communication targets.

In one aspect of the present example embodiment, the controller controls the light source such that modulated light derived from light emitted from at least two of the plurality of emitters is emitted toward the same curved mirror included in the plurality of reflectors. According to the present aspect, the spatial light signal can be spatially multiplexed by reflecting the modulated light derived from the emitted light by the plurality of curved mirrors.

In one aspect of the present example embodiment, the plurality of curved mirrors are disposed with their reflection surfaces facing different projection directions. According to the present aspect, the spatial light signal can be transmitted toward the communication targets in various directions by the plurality of curved mirrors disposed with the reflection surfaces facing different projection directions. For example, according to the present aspect, the spatial light signal can be transmitted in the direction of 360 degrees in the same reference plane (for example, horizontal plane) by adjusting the direction and curvature of the reflection surface included in the plurality of curved mirrors.

### Second Example Embodiment

(Configuration)

Next, a communication device according to a second example embodiment will be described with reference to the drawings. The communication device of the present example embodiment has a configuration in which a reception device and a transmission device are combined. The transmission device has the configuration of the first example embodiment. The reception device receives the spatial light signal. Hereinafter, an example of a reception device having a light receiving function including a ball lens will be described. The communication device of the present example embodiment may include a reception device including a light receiving function that does not include a ball lens.

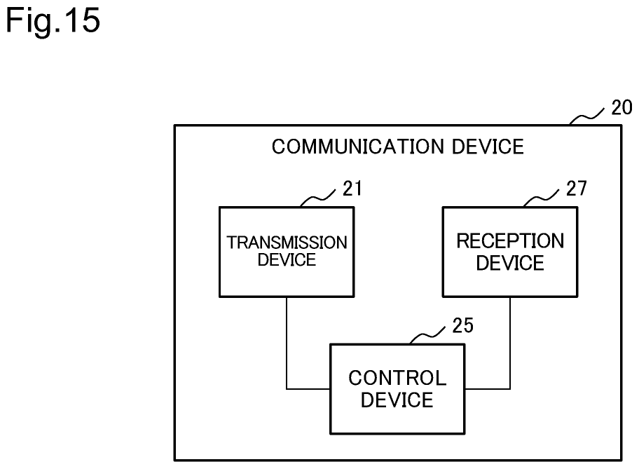

FIG. 15 is a conceptual diagram illustrating an example of a configuration of a communication device 20 according to the present example embodiment. The communication device 20 includes a transmission device 21, a control device 25, and a reception device 27. The communication device 20 transmits and receives spatial light signals to and from an external communication target. Therefore, an opening or a window for transmitting and receiving a spatial light signal is formed in the communication device 20.

The transmission device 21 is the transmission device of the first example embodiment. The transmission device 21 acquires a control signal from the control device 25. The transmission device 21 projects a spatial light signal according to the control signal. The spatial light signal projected from the transmission device 21 is received by a communication target (not illustrated) of a transmission destination of the spatial light signal.

The control device 25 acquires a signal output from the reception device 27. The control device 25 executes processing according to the acquired signal. The processing executed by the control device 25 is not particularly limited. The control device 25 outputs a control signal for transmitting an optical signal corresponding to the executed processing to the transmission device 21. For example, the control device 25 executes processing based on a predetermined condition according to information included in the signal received by the reception device 27. For example, the control device 25 executes processing designated by an administrator of the communication device 20 according to information included in the signal received by the reception device 27.

The reception device 27 receives a spatial light signal transmitted from a communication target (not illustrated). The reception device 27 converts the received spatial light signal into an electric signal. The reception device 27 outputs the converted electric signal to the control device 25. For example, the reception device 27 has a light receiving function including a ball lens. The reception device 27 may have a light receiving function that does not include a ball lens.

### [Reception Device]

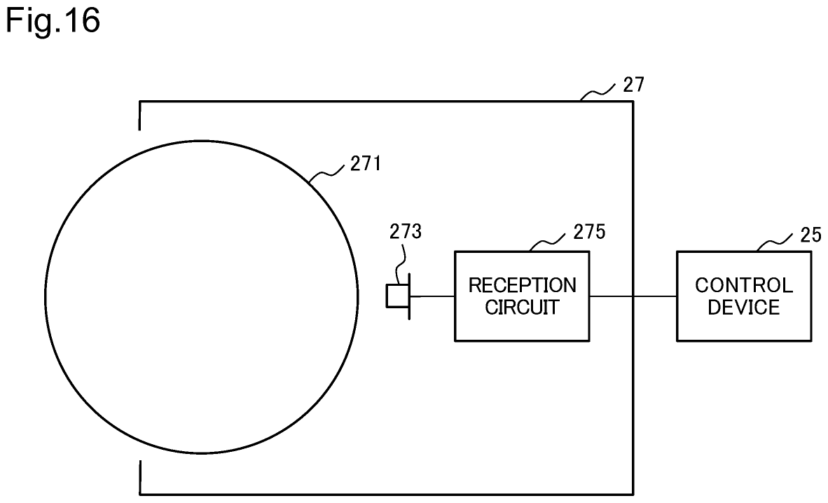

Next, a configuration of the reception device 27 will be described with reference to the drawings. FIG. 16 is a conceptual diagram for explaining an example of a configuration of the reception device 27. The reception device 27 includes a ball lens 271, a light receiving element 273, and a reception circuit 275. FIG. 16 is a side view of the internal configuration of the reception device 27 as viewed from the lateral direction. The position of the reception circuit 275 is not particularly limited. The reception circuit 275 may be disposed inside the reception device 27 or may be disposed outside the reception device 27. The function of the reception circuit 275 may be included in the control device 25.

The ball lens 271 is a spherical lens. The ball lens 271 is an optical element that collects a spatial light signal transmitted from a communication target. The ball lens 271 has a spherical shape when viewed from an angle. Apart of the ball lens 271 protrudes from an opening opened in a housing of the reception device 27. The ball lens 271 collects the incident spatial light signal. The spatial light signal incident on the ball lens 271 protruding from the opening is collected. As long as the spatial light signal can be condensed, a part of the ball lens 271 may not protrude from the opening.

Light (also referred to as an optical signal) derived from the spatial light signal condensed by the ball lens 271 is condensed toward the condensing region of the ball lens 271. Since the ball lens 271 has a spherical shape, the ball lens collects a spatial light signal arriving from any direction. That is, the ball lens 271 exhibits similar light condensing performance for a spatial light signal arriving from any direction. The light incident on the ball lens 271 is refracted when entering the inside of the ball lens 271. The light traveling inside the ball lens 271 is refracted again when being emitted to the outside of the ball lens 271. Most of the light emitted from the ball lens 271 is condensed in the condensing region.

For example, the ball lens 271 can be made of a material such as glass, crystal, or resin. In the case of receiving a spatial light signal in the visible region, the ball lens 271 can be achieved by a material such as glass, crystal, or resin that transmits/refracts light in the visible region. For example, the ball lens 271 can be achieved by optical glass such as crown glass or flint glass. For example, the ball lens 271 can be achieved by a crown glass such as BK (Boron Kron). For example, the ball lens 271 can be achieved by a flint glass such as Lanthanum Schwerflint (LaSF). For example, quartz glass can be applied to the ball lens 271. For example, a crystal such as sapphire can be applied to the ball lens 271. For example, a transparent resin such as acrylic can be applied to the ball lens 271.

In a case where the spatial light signal is light in a near-infrared region (hereinafter, also referred to as near-infrared rays), a material that transmits near-infrared rays is used for the ball lens 271. For example, in a case of receiving a spatial light signal in a near-infrared region of about 1.5 micrometers (μm), a material such as silicon can be applied to the ball lens 271 in addition to glass, crystal, resin, and the like. In a case where the spatial light signal is light in an infrared region (hereinafter, also referred to as infrared rays), a material that transmits infrared rays is used for the ball lens 271. For example, in a case where the spatial light signal is an infrared ray, silicon, germanium, or a chalcogenide material can be applied to the ball lens 271. The material of the ball lens 271 is not limited as long as light in the wavelength region of the spatial light signal can be transmitted/refracted. The material of the ball lens 271 may be appropriately selected according to the required refractive index and use.

The ball lens 271 may be replaced with another concentrator as long as the spatial light signal can be condensed toward the region where the light receiving element 273 is disposed. For example, the ball lens 271 may be a light beam control element that guides the incident spatial light signal toward the light receiving unit of the light receiving element 273. For example, the ball lens 271 may have a configuration in which a lens or a light beam control element is combined. For example, a mechanism that guides the optical signal condensed by the ball lens 271 toward the light receiving unit of the light receiving element 273 may be added.

The light receiving element 273 is disposed at a subsequent stage of the ball lens 271. The light receiving element 273 is disposed in the condensing region of the ball lens 271. The light receiving element 273 includes a light receiving unit that receives the optical signal collected by the ball lens 271. The optical signal collected by the ball lens 271 is received by the light receiving unit of the light receiving element 273. The light receiving element 273 converts the received optical signal into an electric signal (hereinafter, also referred to as a signal). The light receiving element 273 outputs the converted signal to the reception circuit 275. FIG. 16 illustrates an example in which the light receiving element 273 is a single element. For example, the plurality of light receiving elements 273 may be arranged in the condensing region of the ball lens 271. For example, a light receiving element array in which a plurality of light receiving elements 273 are arrayed may be disposed in the condensing region of the ball lens 271.

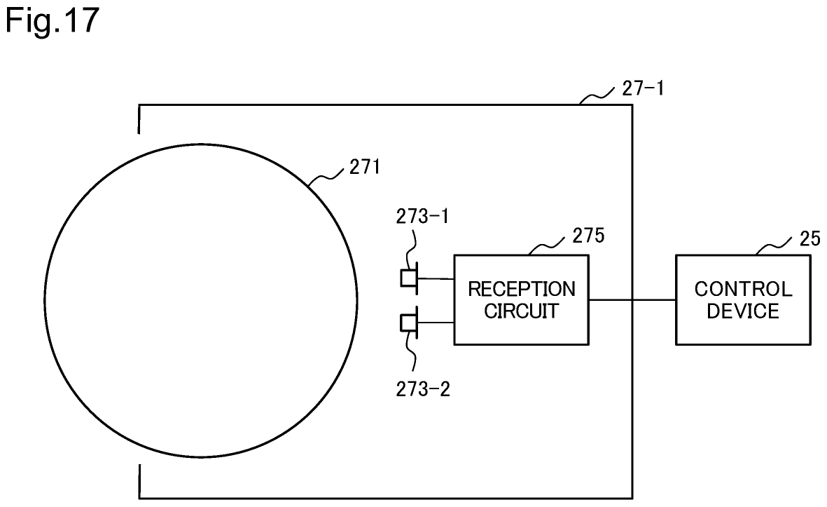

FIG. 17 is a conceptual diagram illustrating an example (reception device 27-1) of the reception device 27 in which the two light receiving elements 273-1 and 273-2 are arranged in the condensing region of the ball lens 271. The light receiving element 273-1 and the light receiving element 273-2 receive light of different wavelength bands. The optical signals received by the light receiving element 273-1 and the light receiving element 273-2 are individually processed by the reception circuit 275. If light of different wavelength bands can be individually processed, optical signals wavelength-multiplexed in those wavelength bands can be processed. The number of the light receiving elements 273 is not limited as long as the light receiving elements can be disposed in the condensing region of the ball lens 271.

The light receiving element 273 receives light in a wavelength region of the spatial light signal to be received. For example, the light receiving element 273 has sensitivity to light in the visible region. For example, the light receiving element 273 has sensitivity to light in an infrared region. The light receiving element 273 has sensitivity to light having a wavelength in a 1.5 μm (micrometer) band, for example. The wavelength band of light with which the light receiving element 273 has sensitivity is not limited to the 1.5 μm band. The wavelength band of the light received by the light receiving element 273 can be set in accordance with the wavelength of the spatial light signal to be received. The wavelength band of the light received by the light receiving element 273 may be set to, for example, a 0.8 μm band, a 1.55 μm band, or a 2.2 μm band. The wavelength band of the light received by the light receiving element 273 may be, for example, a 0.8 to 1 μm band. A shorter wavelength band is advantageous for optical space communication during rainfall because absorption by moisture in the atmosphere is small. If the light receiving element 273 is saturated with intense sunlight, the light receiving element cannot read the optical signal derived from the spatial light signal. Therefore, a color filter that selectively passes the light of the wavelength band of the spatial light signal may be installed at the preceding stage of the light receiving element 273.

For example, the light receiving element 273 can be achieved by an element such as a photodiode or a phototransistor. For example, the light receiving element 273 is achieved by an avalanche photodiode. The light receiving element 273 achieved by the avalanche photodiode can support high-speed communication. The light receiving element 273 may be achieved by an element other than a photodiode, a phototransistor, or an avalanche photodiode as long as an optical signal can be converted into an electric signal. In order to improve the communication speed, the light receiving unit of the light receiving element 273 may be as small as possible. For example, the light receiving unit of the light receiving element 273 has a square light receiving surface having a side of about 5 mm (mm). For example, the light receiving unit of the light receiving element 273 has a circular light receiving surface having a diameter of about 0.1 to 0.3 mm. The size and shape of the light receiving unit of the light receiving element 273 may be selected according to the wavelength band, the communication speed, and the like of the spatial light signal.

For example, a polarizing filter (not illustrated) may be disposed in the preceding stage of the light receiving element 273. The polarizing filter is disposed in association with the light receiving unit of the light receiving element 273. For example, the polarizing filter is disposed to overlap the light receiving unit of the light receiving element 273. For example, the polarizing filter may be selected according to the polarization state of the spatial light signal to be received. For example, when the spatial light signal to be received is linearly polarized light, the polarizing filter includes a ½ wave plate. For example, when the spatial light signal to be received is circularly polarized light, the polarizing filter includes a ¼ wave plate. The polarization state of the optical signal having passed through the polarizing filter is converted according to the polarization characteristic of the polarizing filter.

The reception circuit 275 acquires a signal output from the light receiving element 273. The reception circuit 275 amplifies the signal from the light receiving element 273. The reception circuit 275 decodes the amplified signal. The signal decoded by the reception circuit 275 is used for any purpose. The use of the signal decoded by the reception circuit 275 is not particularly limited.

### [Communication Device]

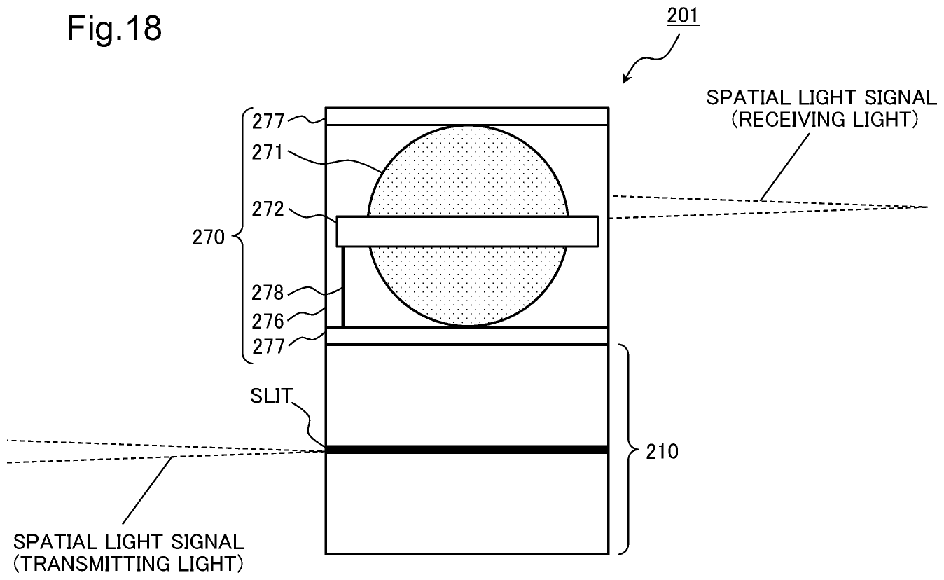

FIG. 18 is a conceptual diagram illustrating an example (communication device 201) of the communication device 20. The communication device 201 includes a transmitter 210, a receiver 270, and a control device (not illustrated). In FIG. 18, a reception circuit and a control device are omitted. The communication device 201 has a configuration in which the transmitter 210 having a cylindrical outer shape and the receiver 270 are combined.

The receiver 270 includes a ball lens 271, a light receiver 272, a color filter 276, a support member 277, and a conductive wire 278. The upper and lower portions of the ball lens 271 are sandwiched between a pair of support members 277 disposed vertically. Since the upper and lower sides of the ball lens 271 are not used for transmission and reception of spatial light signals, they may be processed into a planar shape so as to be easily sandwiched by the support member 277. The light receiver 272 is disposed in accordance with the condensing region of the ball lens 271 so as to be able to receive the spatial light signal to be received. The light receiver 272 includes a light receiving element array in which a plurality of light receiving elements are annularly arranged. The plurality of light receiving elements are disposed in the condensing region of the ball lens 271. The plurality of light receiving elements are disposed with the light receiving unit facing the ball lens 271. The plurality of light receiving elements are connected to a control device (not illustrated) and the transmitter 210 by the conductive wire 278.

The color filter 276 is disposed on a side surface of the cylindrical receiver 270. The color filter 276 removes unnecessary light and selectively transmits a spatial light signal used for communication. A pair of support members 277 is disposed on upper and lower surfaces of the cylindrical receiver 270. The pair of support members 277 sandwich the ball lens 271 from above and below. The light receiver 272 formed in an annular shape is disposed on the emission side of the ball lens 271. The spatial light signal incident on the ball lens 271 through the color filter 276 is condensed toward the light receiver 272 by the ball lens 271. The optical signal condensed on the light receiver 272 is guided toward the light receiving unit of one of the light receiving elements. The i=optical signal reaching the light receiving unit of the light receiving element is received by the light receiving element. A control device (not illustrated) causes the transmitter 210 to transmit a spatial light signal according to an optical signal received by the light receiving element included in the light receiver 272.

The transmitter 210 is configured by the transmission device 10 in the first example embodiment. The transmitter 210 is housed inside a cylindrical housing. A slit opened in accordance with the transmission direction of the spatial light signal by the transmitter 210 is formed in the cylindrical housing. For example, in a case where the transmitter 210 can transmit the spatial light signal in a direction of 360 degrees, a slit is formed on the side surface of the housing of the transmitter 210 in accordance with the transmission direction of the spatial light signal.

### Application Example

Next, an application example of the communication device 20 of the present example embodiment will be described with reference to the drawings. Hereinafter, two application examples (Application Examples 1 and 2) will be described. In the following application example, an example in which a plurality of communication devices transmits and receives a spatial light signal will be described. Any of the communication devices has the same configuration as the communication device according to the second example embodiment.

### Application Example 1

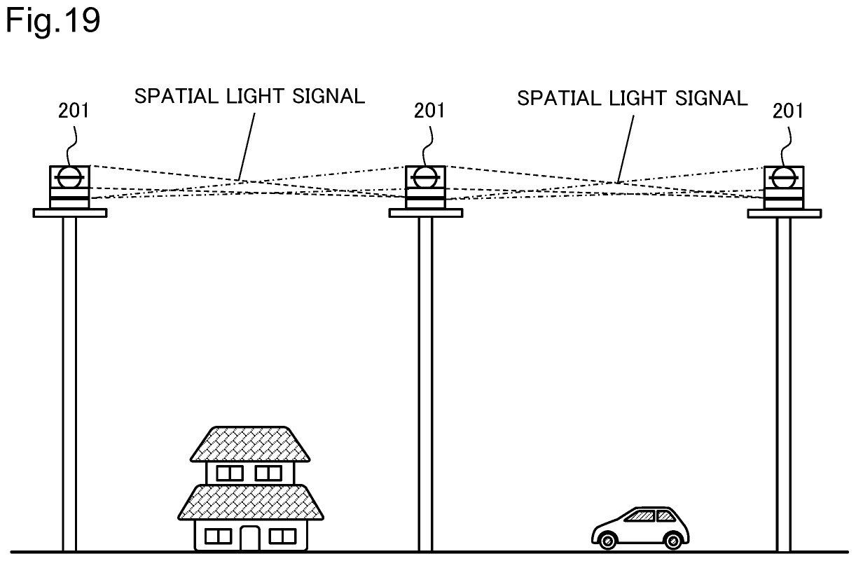

FIG. 19 is a conceptual diagram for explaining Application Example 1. In the present application example, an example (also referred to as a communication system) of a communication network in which a plurality of communication devices 201 are disposed on an upper portion (also referred to as an on-pole space) of a pole such as a utility pole or a street lamp disposed in a town will be described.

There are few obstacles in the on-pole space. Therefore, the on-pole space is suitable for installing the communication device 201. If the communication device 201 is installed at the same height, the arrival direction of the spatial light signal is limited to the horizontal direction. Therefore, the light receiving area of the light receiver constituting the receiver 270 can be reduced, and the device can be simplified. The pair of communication devices 201 that transmit and receive the spatial light signal is disposed such that at least one communication device 201 receives the spatial light signal transmitted from the other communication device 201. The pair of communication devices 201 may be disposed to transmit and receive spatial light signals to and from each other. In a case where the communication network of the spatial light signal is configured by the plurality of communication devices 201, the communication device 201 positioned in the middle may be disposed to relay the spatial light signal transmitted from another communication device 201 to another communication device 201.

According to the present application example, communication using a spatial light signal can be performed among the plurality of communication devices 201 disposed in the on-pole space. For example, communication by wireless communication may be performed between a wireless device or a base station installed in an automobile, a house, or the like and the communication device 201 according to communication between the communication devices 201. For example, the communication device 201 may be connected to the Internet via a communication cable or the like installed on a pole.

### Application Example 2

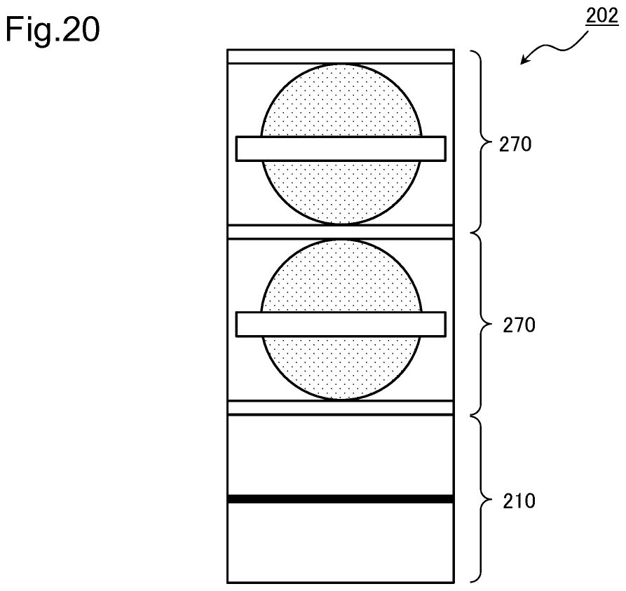

FIG. 20 is a conceptual diagram for explaining a communication device 202 of Application Example 2. The communication device 202 of the present application example is used for transmission and reception of spatially multiplexed spatial light signals. The communication device 202 includes the transmitter 210 and two receivers 270. In the example of FIG. 20, two receivers 270 are disposed above the transmitter 210 in an overlapping manner. The transmitter 210 may be disposed between the two receivers 270, or may be disposed above the two receivers 270. The two receivers 270 may be configured to receive spatial light signals of the same wavelength band, or may be configured to receive spatial light signals of different wavelength bands.

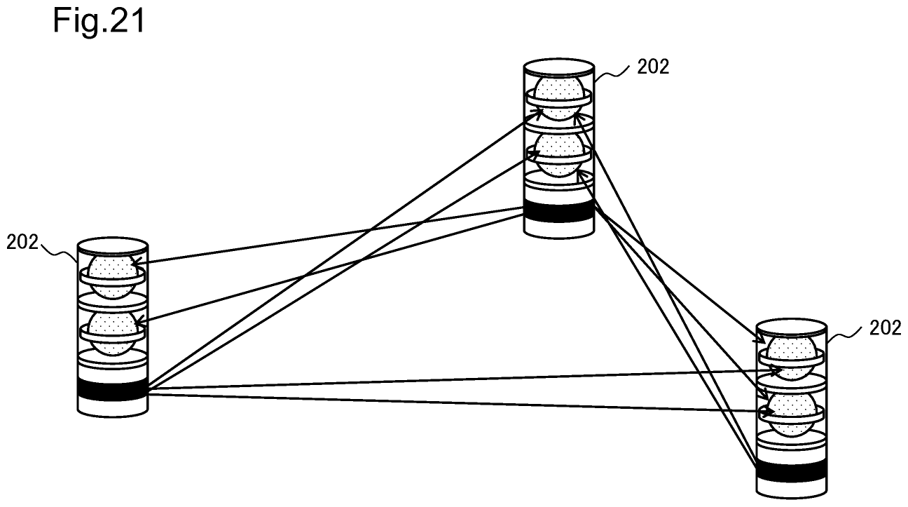

FIG. 21 is a conceptual diagram of an example (communication system) of a communication network in which a plurality of communication devices 202 are disposed. The installation environment of the plurality of communication devices 202 is not limited. For example, as in Application Example 1, the plurality of communication devices 202 are disposed in the on-pole space. The communication device 202 multiplexes two of the plurality of reflectors included in the transmitter 210 to transmit the spatially multiplexed spatial light signal to the other communication device 20. The communication device 202 receives the multiplexed spatial light signal transmitted from the other communication device 202. The communication device 202 processes the received spatial light signal for each communication target. That is, according to the present application example, communication using spatially multiplexed spatial light signals becomes possible.

As described above, the communication device according to the present example embodiment includes the reception device, the transmission device, and the control device. The transmission device includes a light source, a spatial light modulator, a concentrator, a projector, and a controller. The light source includes a plurality of emitters. The spatial light modulator includes a modulation part in which a plurality of modulation regions are set. The concentrator converts the modulated light modulated in the plurality of modulation regions into parallel light. The projector is disposed at a subsequent stage of the concentrator. The projector includes at least one reflector. The at least one reflector is supported on a column extending perpendicular to the optical axis of the concentrator. The reflector includes a rotator and a curved mirror. The curved mirror has a reflection surface having a curvature corresponding to the projection angle of the projection light transmitted as the spatial light signal. The rotator rotatably supports the curved mirror. The controller adjusts the reflection direction of the curved mirror for each reflector by controlling the rotator. The controller sets a phase image used for spatial light communication in a plurality of modulation regions. The controller controls the plurality of emitters so that each of the plurality of modulation regions is irradiated with light. The reception device receives the spatial light signal. The control device acquires a signal based on a spatial light signal from another communication device received by the reception device. The control device executes processing according to the acquired signal. The control device causes the transmission device to transmit a spatial light signal corresponding to the executed processing.

In the transmission device included in the communication device of the present example embodiment, the plurality of modulation regions set in the modulation part of the spatial light modulator are irradiated with the parallel light derived from the laser light emitted from the plurality of emitters. The light component of the spatial light signal included in the modulated light modulated in the plurality of modulation regions is transmitted as a spatial light signal by one of the curved mirrors associated with each of the plurality of modulation regions. The direction of the reflection surface of the curved mirror is adjusted by the controller for each reflector. Therefore, according to the communication device of the present example embodiment, spatial light communication using a spatial light signal that can be transmitted in an arbitrary direction can be achieved by adjusting the direction of the reflection surface of the curved mirror for each reflector.

A communication system according to an aspect of the present example embodiment includes a plurality of the above-described communication devices. In a communication system, a plurality of communication devices are disposed to transmit and receive spatial light signals to and from each other. According to the present aspect, it is possible to achieve a communication network that transmits and receives a spatial light signal.

### Third Example Embodiment

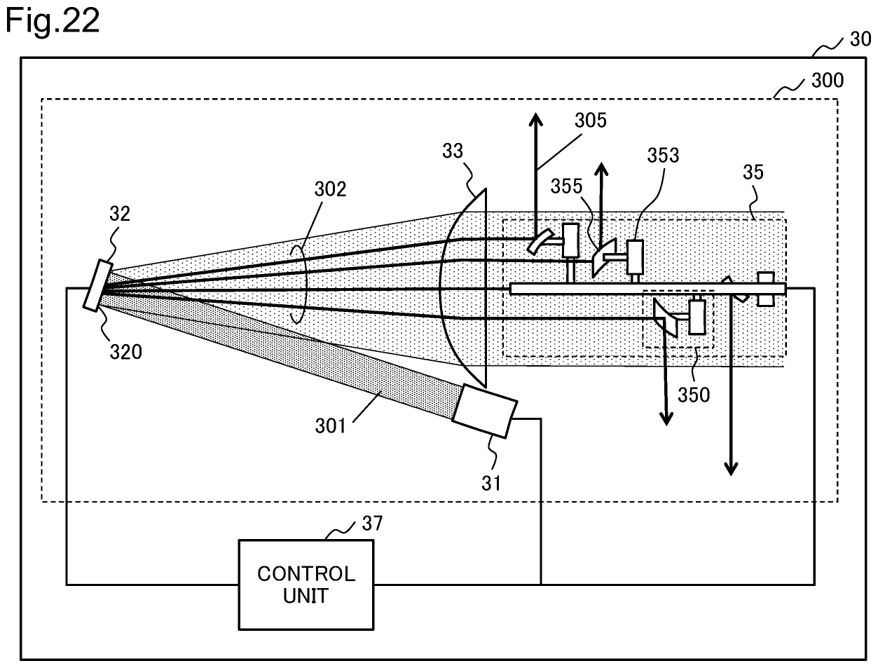

Next, a transmission device according to a third example embodiment will be described with reference to the drawings. The transmission device in the present example embodiment has a configuration in which the transmission device in the first example embodiment is simplified. FIG. 22 is a conceptual diagram illustrating an example of a configuration of a transmission device 30 according to the present example embodiment. FIG. 22 is a side view of an internal configuration of the transmission device 30 as viewed from a lateral direction. The transmission device 30 includes a light source 31, a spatial light modulator 32, a concentrator 33, a projection mechanism 35, and a control unit 37. The light source 31, the spatial light modulator 32, the concentrator 33, and the projection mechanism 35 constitute a transmitter 300.

The light source 31 includes a plurality of emitters. For example, the plurality of emitters emit laser light. The light source emits parallel light 301 derived from the laser light emitted from the plurality of emitters. The spatial light modulator 32 includes a modulation part 320 in which a plurality of modulation regions are set. The concentrator 33 converts the modulated light 302 modulated in the plurality of modulation regions into parallel light. The projection mechanism 35 (projector) is disposed at a subsequent stage of the concentrator 33. The projection mechanism 35 includes at least one reflection unit 350. The reflection unit 350 (reflector) includes a rotation mechanism 353 (rotator) and a curved mirror 355. The reflection surface of the curved mirror 355 has a curvature corresponding to the projection angle of the projection light 305 transmitted as the spatial light signal. The rotation mechanism 353 rotatably supports the curved mirror 355. The control unit 37 (controller) adjusts the reflection direction of the curved mirror 355 for each reflection unit 350 by controlling the rotation mechanism 353. The control unit 37 sets a phase image used for spatial light communication in a plurality of modulation regions. The control unit 37 controls the plurality of emitters such that each of the plurality of modulation regions is irradiated with light.

As described above, in the present example embodiment, the plurality of modulation regions set in the modulation part of the spatial light modulator are irradiated with the parallel light derived from the laser light emitted from the plurality of emitters. The light component of the spatial light signal included in the modulated light modulated in the plurality of modulation regions is transmitted as a spatial light signal by one of the curved mirrors associated with each of the plurality of modulation regions. The direction of the reflection surface of the curved mirror is adjusted by the controller for each reflector. Therefore, according to the transmission device of the present example embodiment, the spatial light signal can be transmitted in an arbitrary direction by adjusting the direction of the reflection surface of the curved mirror for each reflector.

(Hardware)

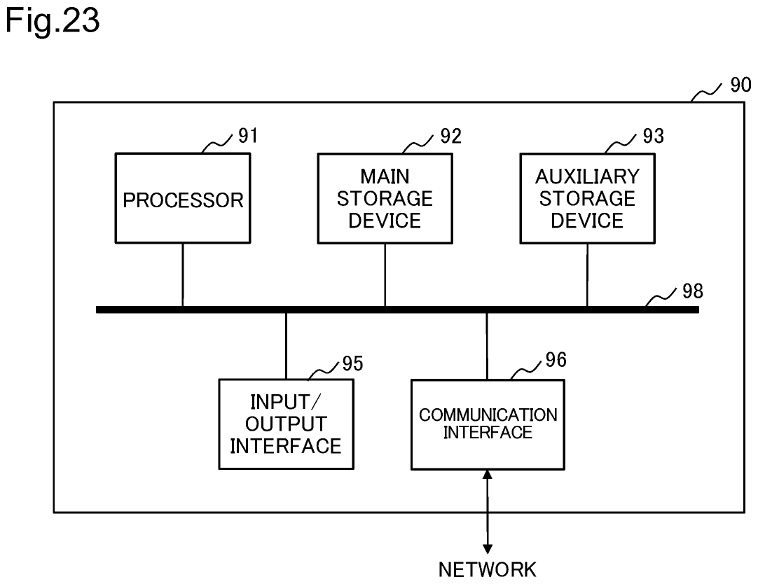

Here, a hardware configuration for executing the control and processing according to each example embodiment of the present disclosure will be described using an information processing device 90 (computer) of FIG. 23 as an example. The information processing device 90 in FIG. 23 is a configuration example for executing the control and processing of each example embodiment, and does not limit the scope of the present disclosure.

As illustrated in FIG. 23, the information processing device 90 includes a processor 91, a main storage device 92, an auxiliary storage device 93, an input/output interface 95, and a communication interface 96. In FIG. 23, the interface is abbreviated as an I/F. The processor 91, the main storage device 92, the auxiliary storage device 93, the input/output interface 95, and the communication interface 96 are data-communicably connected to each other via a bus 98. The processor 91, the main storage device 92, the auxiliary storage device 93, and the input/output interface 95 are connected to a network such as the Internet or an intranet via the communication interface 96.

The processor 91 develops a program (instruction) stored in the auxiliary storage device 93 or the like in the main storage device 92. For example, the program is a software program for executing the control and processing of each example embodiment. The processor 91 executes the program developed in the main storage device 92. The processor 91 executes the control and processing according to each example embodiment by executing the program.

The main storage device 92 has an area in which a program is developed. A program stored in the auxiliary storage device 93 or the like is developed in the main storage device 92 by the processor 91. The main storage device 92 is implemented by, for example, a volatile memory such as a dynamic random access memory (DRAM). A nonvolatile memory such as a magneto resistive random access memory (MRAM) may be configured and added as the main storage device 92.

The auxiliary storage device 93 stores various data such as programs. The auxiliary storage device 93 is implemented by a local disk such as a hard disk or a flash memory. Various data may be stored in the main storage device 92, and the auxiliary storage device 93 may be omitted.

The input/output interface 95 is an interface for connecting the information processing device 90 and a peripheral device. The communication interface 96 is an interface for connecting to an external system or device through a network such as the Internet or an intranet based on a standard or a specification. The input/output interface 95 and the communication interface 96 may be shared as an interface connected to an external device.

An input device such as a keyboard, a mouse, or a touch panel may be connected to the information processing device 90 as necessary. These input devices are used to input information and settings. When a touch panel is used as the input device, a screen having a touch panel function serves as an interface. The processor 91 and the input device are connected via the input/output interface 95.

The information processing device 90 may be provided with a display device for displaying information. In a case where a display device is provided, the information processing device 90 may include a display control device (not illustrated) for controlling display of the display device. The display device may be connected to the information processing device 90 via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via an input/output interface 95.

The above is an example of the hardware configuration for enabling the control and processing according to each example embodiment of the present invention. The hardware configuration of FIG. 23 is an example of a hardware configuration for executing the control and processing of each example embodiment, and does not limit the scope of the present invention. A program for causing a computer to execute the control and processing according to each example embodiment is also included in the scope of the present invention.

Further, a program recording medium in which the program according to each example embodiment is recorded is also included in the scope of the present invention. The recording medium can be implemented by, for example, an optical recording medium such as a compact disc (CD) or a digital versatile disc (DVD). The recording medium may be implemented by a semiconductor recording medium such as a universal serial bus (USB) memory or a secure digital (SD) card. The recording medium may be implemented by a magnetic recording medium such as a flexible disk, or another recording medium. When a program executed by the processor is recorded in a recording medium, the recording medium is associated to a program recording medium.

The components of each example embodiment may be arbitrarily combined. The components of each example embodiment may be implemented by software. The components of each example embodiment may be implemented by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A transmission device comprising:
a light source that includes a plurality of emitters;
a spatial light modulator that includes a modulation part in which a plurality of modulation regions are set;
a concentrator that converts modulated light modulated in the plurality of modulation regions into parallel light;
a projector that is disposed at a subsequent stage of the concentrator and includes at least one reflector including a curved mirror having a reflection surface of a curved shape having a curvature according to a projection angle of projection light transmitted as a spatial light signal and a rotator rotatably supporting the curved mirror; and
a controller configured to control the rotator to adjust a reflection direction of the curved mirror for each of the reflectors, set a phase image used for spatial light communication in the plurality of modulation regions, and control the plurality of emitters such that each of the plurality of modulation regions is irradiated with light.

2. The transmission device according to claim 1, wherein
the plurality of reflectors are supported on a column extended perpendicular to an optical axis of the concentrator, and
the curved mirror included in the plurality of reflectors is located at a position avoiding a region where 0th-order light and a higher-order image included in the modulated light are projected.

3. The transmission device according to claim 2, wherein
the controller is configured to control the light source such that the modulated light derived from light emitted from at least one of the plurality of emitters is emitted toward the curved mirrors included in the plurality of reflectors.

4. The transmission device according to claim 2, wherein
the controller is configured to control the light source such that the modulated light derived from light emitted from at least two of the plurality of emitters is emitted toward the same curved mirror included in the plurality of reflectors.

5. The transmission device according to claim 2, wherein a plurality of the curved mirrors are disposed with the reflection surface facing different projection directions.

6. The transmission device according to claim 1, wherein
the controller is configured to set the phase image in the modulation region such that the reflection surface of the same curved mirror is irradiated with the modulated light derived from light of different wavelength bands emitted from at least two of the plurality of emitters.

7. The transmission device according to claim 1, wherein
the concentrator is a plano-convex lens disposed with a convex surface facing the modulation part of the spatial light modulator and a flat surface facing the projector.

8. The transmission device according to claim 1, comprising: a light absorber that absorbs a light component not reflected by the projector among light condensed by the concentrator.

9. A communication device comprising:
the transmission device according to claim 1;
a reception device that receives a spatial light signal; and
a control device configured to acquire a signal based on a spatial light signal from another communication device received by the reception device, execute processing according to the acquired signal, and cause the transmission device to transmit a spatial light signal according to the executed processing.

10. A communication system comprising:
a plurality of the communication devices according to claim 9, wherein
the plurality of the communication devices are disposed to transmit and receive spatial light signals to and from each other.
